(19) United States
(12) Patent Application Publication
(10) Pub. No.: US 2015/0279277 A1
(43) Pub. Date: Oct. 1, 2015

(54) Pixel Driving Circuit of OLED Display and the Driving Method Thereof

(71) Applicant: Xiangyang Xu, Shenzhen (CN)

(72) Inventor: Xiangyang Xu, Shenzhen (CN)

(73) Assignee: Shenzhen China Star Optoelectronics Technology Co., Ltd., Shenzhen, Guabgdong (CN)

(21) Appl. No.: 14/374,269

(22) PCT Filed: Apr. 17, 2014
(86) PCT No.: PCT/CN2014/075578

§ 371 Date: Jul. 24, 2014

(30) Foreign Application Priority Data
Apr. 1, 2014 (CN) 201410127995.8

(51) Int. Cl. G09G 3/32

(52) U.S. Cl. CPC G09G 3/3258; G09G 3/3266; G09G 3/3291; G09G 2300/0852; G09G 2300/0819; G09G 2310/062; G09G 2310/0248; G09G 2310/027; G09G 2320/0233; G09G 2320/0626

(57) ABSTRACT

The present invention discloses a pixel driving circuit of OLED display, which utilizes a 6T2C structure, at least comprising: a scanning transistor TFT1, a driving transistor TFT2, a first compensation transistor TFT3, a second compensation transistor TFT4, a first reset transistor TFT5, a second reset transistor TFT6, an organic light emitting diode OLED, a coupling capacitor C1, and a storage capacitor C2. Correspondingly, the embodiment of the present invention further discloses a driving method of the pixel driving circuit of OLED display. The embodiment of the present invention can compensate the shift of the threshold voltage of the driving transistor, which improves the grayscale and image uniformity of OLED.

This application is claiming a priority arisen from a patent application, entitled with “Pixel Driving Circuit of OLED Display and the Driving Method Thereof”, submitted to China Patent Office on Apr. 1, 2014, designated with an Application Number 201410127995.8. The whole and complete disclosure of such patent application is hereby incorporated by reference. This application also related to National Stage application No. ______ (Attorney Docket No. CP14025), submitted on the same date, entitled, “Pixel Driving Circuit and Array Substrate of OLED Display and the Corresponding Display”; and National Stage application No. ______ (Attorney Docket No. CP14026), submitted on the same date, entitled, “Array Substrate of OLED Display” assigned to the same assignee.

### BACKGROUND OF THE INVENTION

1. Field of the Invention

The present invention relates to the fields of pixel driving technology of the light emitting diode display, and in particular to a pixel driving circuit of organic light emitting diode (OLED) display and the driving method thereof.

2. the Related Arts

As a new generation of display technology, Organic Light Emitting Diode (OLED) has advantages of low power consumption, high color gamut, high brightness, high resolution, wide viewing angle, high response speed, and etc. Hence, it is favored in marketing.

However, with the development of display technology, the passive array OLED has been unable to meet the requirements of high resolution and a large amount of information. For the large-screen and high-resolution display, it usually utilizes the driving mode of active array OLED.

FIG. 1 shows a schematic view illustrating the driving circuit of active array OLED of a traditional 2T1C. Wherein, 2T1C represents the circuit comprising 2 TFT transistors and one capacitor C. TFT is thin film transistor, which is mainly used to control the charge of the capacitor C. TFT2 is OLED driving transistor, which is mainly used to drive OLED. Capacitor C is mainly used to store the data signal grayscale voltage and then controls the driving current of the TFT2 for OLED. Gate n is the n-th row scanning signal line. Data n is the n-th column signal line. Vdd is OLED driving line.

The thin film transistor applied in active array OLED is mainly hydroxide amorphous silicon transistor (a-Si TFT) and low-temperature polysilicon thin film transistor (LTPS TFT). Wherein, the threshold voltage and the channel mobility of the LTPS TFT are not uniform enough in spatial distribution. However, the threshold voltage and the channel mobility of the a-Si TFT will shift over time. These disadvantages will lead to the threshold voltage of each pixel driving TFT not uniform in OLED display screen, so the brightness of the OLED in each pixel is not uniform and not stable. In the actual OLED display panel production, the uniformity should be controlled in ±1%. Therefore, it needs to introduce various pixel compensation circuits, so that the uniformity and the stability of the brightness of the display screen can meet the product requirements.

### SUMMARY OF THE INVENTION

The technical issue to be solved by the present invention is to provide a pixel driving circuit of organic light emitting diode (OLED) display and the driving method thereof, which can compensate the shift of the threshold voltage of the driving transistor, and improve the grayscale and image uniformity of OLED.

In order to solve the technical issue, the present invention provides a pixel driving circuit of OLED display, comprising:

a scanning transistor TFT1, the source thereof being connected to a data line, the gate thereof being connected to a scanning control line, and the drain thereof being connected to a first terminal of a coupling capacitor C1;
a driving transistor TFT2, the gate thereof being connected to a second terminal of the coupling capacitor C1, and the scanning transistor TFT1 being used to control the coupling capacitor C1 to write a grayscale data voltage provided from the data line for the driving transistor TFT2;
a first compensation transistor TFT3, the source thereof being connected to the second terminal of the coupling capacitor C1, the drain thereof being connected to the drain of the driving transistor TFT2, and the gate thereof receiving a second switch driving signal SW2;
a second compensation transistor TFT4, the source thereof being connected to the drain of the driving transistor TFT2, the drain thereof being grounded, and the gate thereof receiving a fourth switch driving signal SW4;
a first reset transistor TFT5, the source thereof being connected to the gate of the driving transistor TFT2, the drain thereof being grounded, the gate thereof being connected to a first switch driving signal SW1, and a storage capacitor C2 be connected between the source and the gate thereof;
a second reset transistor TFT6, the source thereof being connected to the drain of the scanning transistor TFT1, the drain thereof being grounded, and the gate thereof being connected to a third switch driving signal SW3; and
an organic light emitting diode OLED, the negative electrode thereof being connected to the source of the driving transistor TFT2, and the positive electrode thereof being connected to a power line Vdd.

Wherein, the scanning transistor TFT1, the driving transistor TFT2, the first compensation transistor TFT3, the second compensation transistor TFT4, the first reset transistor TFT5, and the second reset transistor TFT6 are selected from a polysilicon thin film transistor, an amorphous silicon thin film transistor, a zinc oxide thin film transistor or an organic thin film transistor.

Wherein, the first switch driving signal SW1, the second switch driving signal SW2, the third switch driving signal SW3, and the fourth switch driving signal SW4 are provided from an external timing controller Tcon.

Correspondingly, the embodiment of the present invention further provides a pixel driving circuit of OLED display, comprising:

a scanning transistor TFT1, the source thereof being connected to a data line, the gate thereof being connected to a scanning control line, and the drain thereof being connected to a first terminal of a coupling capacitor C1;
a driving transistor TFT2, the gate thereof being connected to a second terminal of the coupling capacitor C1, and the scanning transistor TFT1 being used to control the coupling capacitor C1 to write a grayscale data voltage provided from the data line for the driving transistor TFT2;
a first compensation transistor TFT3, the source thereof being connected to the second terminal of the coupling capacitor C1, the drain thereof being connected to the drain of the driving transistor TFT2, and the gate thereof receiving a second switch driving signal SW2;
a second compensation transistor TFT4, the source thereof being connected to the drain of the driving transistor TFT2, the drain thereof being grounded, and the gate thereof receiving a fourth switch driving signal SW4;
a first reset transistor TFT5, the source thereof being connected to the gate of the driving transistor TFT2, the drain thereof being grounded, and the gate thereof being connected to a first switch driving signal SW1;
a second reset transistor TFT6, the source thereof being connected to the drain of the scanning transistor TFT1, the drain thereof being grounded, and the gate thereof being connected to a third switch driving signal SW3; and an organic light emitting diode OLED, the negative electrode thereof being connected to the source of the driving transistor TFT2, and the positive electrode thereof being connected to a power line Vdd;
wherein, a storage capacitor C2 be connected between the source of the first reset transistor TFT5 and the negative electrode of the organic light emitting diode OLED.

Wherein, the scanning transistor TFT1, the driving transistor TFT2, the first compensation transistor TFT3, the second compensation transistor TFT4, the first reset transistor TFT5, and the second reset transistor TFT6 are selected from a polysilicon thin film transistor, an amorphous silicon thin film transistor, a zinc oxide thin film transistor or an organic thin film transistor.

Wherein, the first switch driving signal SW1, the second switch driving signal SW2, the third switch driving signal SW3, and the fourth switch driving signal SW4 are provided from an external timing controller Tcon.

Correspondingly, the embodiment of the present invention further provides a driving method of the pixel driving circuit of OLED display, the method comprising:

a reset stage: a scanning control line, a second switch driving signal SW2, and a fourth switch driving signal SW4 being under low level, a first switch driving signal SW1, and a third switch driving signal SW3 being under high level, a second compensation transistor TFT4, a first reset transistor TFT5, and a second reset transistor TFT6 being turned on, and the gate potential of a driving transistor TFT2 being reset and under low level;
a compensation stage: the scanning control line, the first switch driving signal SW1, and the fourth switch driving signal SW4 being under low level, the second switch driving signal SW2 and the third switch driving signal SW3 being under high level, the driving transistor TFT2, a first compensation transistor TFT3, and the second reset transistor TFT6 being turned on, the driving transistor TFT2 being under OFF state when the gate potential of the driving transistor TFT2 reaches the threshold voltage Vth; a charging stage: the first switch driving signal SW1, the second switch driving signal SW2, the third switch driving signal SW3, and the fourth switch driving signal SW4 being under low level, the scanning control line being under high level, a scanning transistor TFT1 being turned on, a coupling capacitor C1 being charged, then the driving transistor TFT2 being turned on, and a grayscale data voltage being wrote into the gate of the driving transistor TFT2 through the coupling capacitor C1; and
an OLED light emitting stage: the scanning control line, the first switch driving signal SW1, the second switch driving signal SW2, and the third switch driving signal SW3 being under low level, the fourth switch driving signal SW4 being under high level, the power line being under high level, the gate-source voltage difference of the driving transistor TFT2 driving the OLED to emit light, and during the OLED light emitting stage, the gate-source voltage difference of the driving transistor TFT2 remaining unchanged until the next frame refresh.

Wherein, in the reset stage, the driving transistor TFT2 is discharged until it is cutoff, and the threshold voltage Vth of the driving transistor is stored in the storage capacitor C2.

The embodiment of the present invention has the following benefits:

The embodiment of the present invention utilizes a pixel driving circuit of organic light emitting diode (OLED) display with 6T2C structure and the driving method thereof, because the current of the driving transistor is independent of the threshold voltage of the transistor when OLED is emitting light, it avoids the effects of the shift of the threshold voltage of the driving transistor on driving OLED, which improves the grayscale and image uniformity of OLED.

### BRIEF DESCRIPTION OF THE DRAWINGS

In order to more clearly illustrate the embodiment of the present invention or the technical issue of the prior art, the accompanying drawings and the detailed descriptions are as follows. Obviously, the following description of the accompanying drawings are only some embodiments according to the present invention, for persons of ordinary skill in this field, they can also obtain other drawings based on these drawings without creative effort.

FIG. 1 is a schematic view illustrating the pixel driving circuit of OLED display according to the existing technology;

FIG. 2 is a schematic view illustrating the pixel driving circuit of OLED display according an embodiment of the present invention;

FIG. 3 is a schematic view illustrating the pixel driving circuit of OLED display according another embodiment of the present invention;

FIG. 4 is a timing diagram of the partial signal shown in FIG. 2; and

FIG. 5 is a timing diagram of the partial signal shown in FIG. 2.

### DETAILED DESCRIPTION OF THE PREFERRED EMBODIMENTS

The detailed descriptions accompanying drawings and the embodiment of the present invention are as follows.

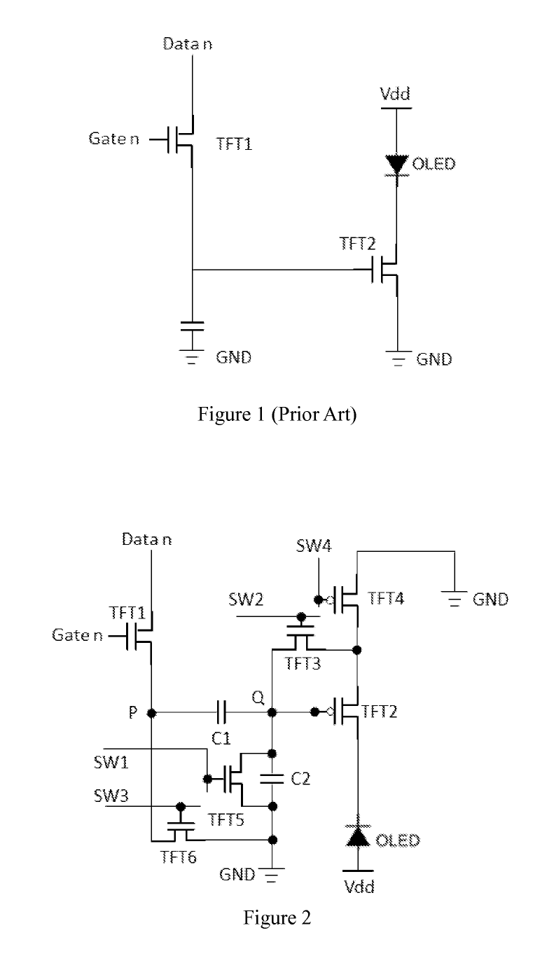

Referring to FIG. 2, it shows a schematic view illustrating the pixel driving circuit of OLED display according an embodiment of the present invention. In the present embodiment, the pixel driving circuit of OLED display is 6T2C structure (that is 6 TFTs and 2 capacitors C), which comprises:

a scanning transistor TFT1, the source thereof being connected to a data line (Data n), the gate thereof being connected to a scanning control line (Gate n), and the drain thereof being connected to a first terminal of a coupling capacitor C1;
a driving transistor TFT2, the gate thereof being connected to a second terminal of the coupling capacitor C1, and the scanning transistor TFT1 being used to control the coupling capacitor C1 to write a grayscale data voltage provided from the data line for the driving transistor TFT2;
a first compensation transistor TFT3, the source thereof being connected to the second terminal of the coupling capacitor C1, the drain thereof being connected to the drain of the driving transistor TFT2, and the gate thereof receiving a second switch driving signal SW2;
a second compensation transistor TFT4, the source thereof being connected to the drain of the driving transistor TFT2, the drain thereof being grounded (GND), and the gate thereof receiving a fourth switch driving signal SW4; a first reset transistor TFT5, the source thereof being connected to the gate of the driving transistor TFT2, the drain thereof being grounded, the gate thereof being connected to a first switch driving signal SW1, and a storage capacitor C2 be connected between the source and the gate thereof;
a second reset transistor TFT6, the source thereof being connected to the drain of the scanning transistor TFT1, the drain thereof being grounded, and the gate thereof being connected to a third switch driving signal SW3; and an organic light emitting diode OLED, the negative electrode thereof being connected to the source of the driving transistor TFT2, and the positive electrode thereof being connected to a power line Vdd.

Wherein, the scanning transistor TFT1, the driving transistor TFT2, the first compensation transistor TFT3, the second compensation transistor TFT4, the first reset transistor TFT5, and the second reset transistor TFT6 are selected from a polysilicon thin film transistor, an amorphous silicon thin film transistor, a zinc oxide thin film transistor or an organic thin film transistor.

Wherein, the first switch driving signal SW1, the second switch driving signal SW2, the third switch driving signal SW3, and the fourth switch driving signal SW4 are provided from an external timing controller Tcon.

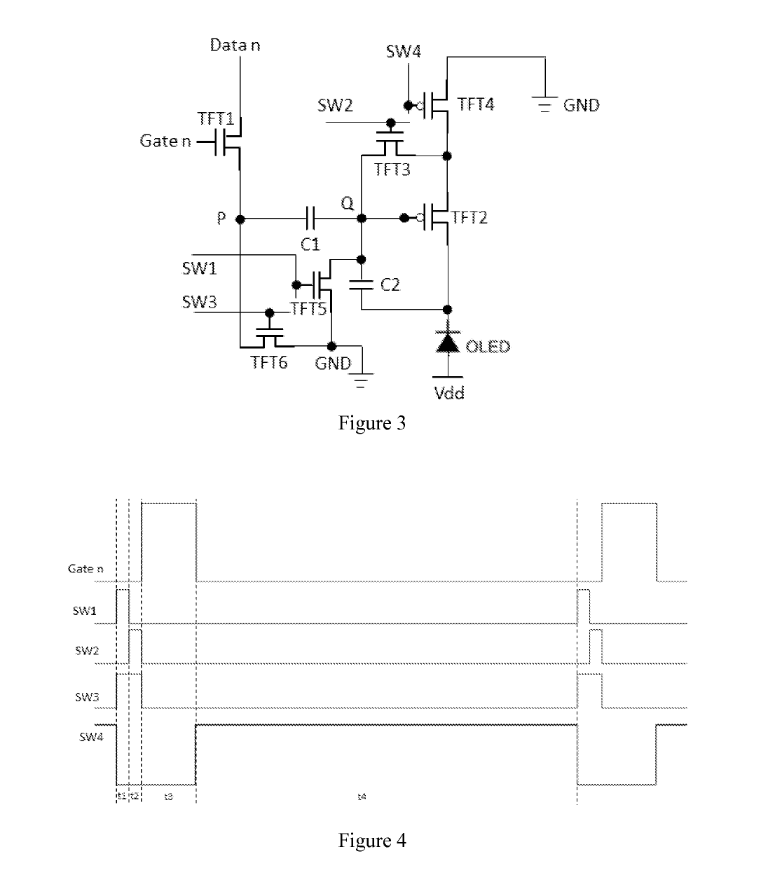

Referring to FIG. 3, it shows a schematic view illustrating the pixel driving circuit of OLED display according another embodiment of the present invention. The structure of the driving circuit according to the embodiment is similar to FIG. 2, and the difference is that the connected positions of the storage capacitor C2 are different. In the present embodiment, the storage capacitor C2 is connected between the source of the first reset transistor TFT5 and the negative electrode of the organic light emitting diode OLED. Other structures and principles can refer to FIG. 2, which is not repeated here.

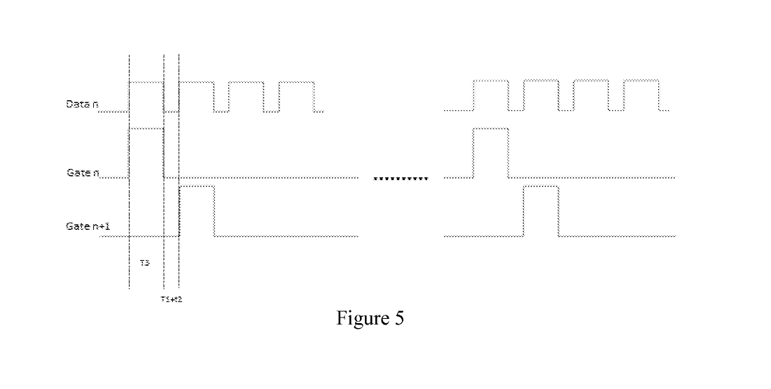

Correspondingly, referring to FIGS. 4 and 5, they show the timing diagram of the circuit shown in FIG. 2. From FIGS. 4 and 5, it can be seen that the embodiment of the present invention further provides a driving method of the pixel driving circuit of OLED display, which comprises the following steps:

a reset stage (t1 stage in FIG. 4): a scanning control line, a second switch driving signal SW2, and a fourth switch driving signal SW4 being under low level, a first switch driving signal SW1, and a third switch driving signal SW3 being under high level, a second compensation transistor TFT4, a first reset transistor TFT5, and a second reset transistor TFT6 being turned on, and the gate potential of a driving transistor TFT2 being reset and under low level; a compensation stage of the threshold voltage Vth of the driving transistor TFT2 (t2 stage in FIG. 4): the scanning control line, the first switch driving signal SW1, and the fourth switch driving signal SW4 being under low level, the second switch driving signal SW2 and the third switch driving signal SW3 being under high level, the driving transistor TFT2, a first compensation transistor TFT3, and the second reset transistor TFT6 being turned on, the driving transistor TFT2 being under OFF state when the gate potential of the driving transistor TFT2 reaches the threshold voltage Vth;
a charging stage of the storage capacitor C2 (t3 stage in FIG. 4): the first switch driving signal SW1, the second switch driving signal SW2, the third switch driving signal SW3, and the fourth switch driving signal SW4 being under low level, the scanning control line being under high level, a scanning transistor TFT1 being turned on, a coupling capacitor C1 being charged, then the driving transistor TFT2 being turned on, and a grayscale data voltage being wrote into the gate of the driving transistor TFT2 through the coupling capacitor C1, specifically, the Q point voltage (that is the gate voltage of the driving transistor TFT2) Vg being:

$$Vg = ( Vdd - Vdata ) \times \frac{C 1}{C 1 + C 2} + Vth \qquad ( 1 )$$

an OLED light emitting stage (t4 stage in FIG. 4): the scanning control line, the first switch driving signal SW1, the second switch driving signal SW2, and the third switch driving signal SW3 being under low level, the fourth switch driving signal SW4 being under high level, the power line being under high level, the second compensation transistor TFT4 and the driving transistor TFT2 being under ON state, the gate-source voltage difference of the driving transistor TFT2 driving the OLED to emit light, and during the OLED light emitting stage, the gate-source voltage difference of the driving transistor TFT2 remaining unchanged until the next frame refresh.

Therefore, during the light emitting stage, the current I flowing through the driving transistor TFT2 is:

I=K×(Vg−Vth)² (II)

Substitute the Vg in the aforementioned formula (I) into the formula (II), then the current flowing through the OLED can be calculated:

$$I = K \times ( ( Vdd - Vdata ) \times \frac{C 1}{C 1 + C 2} ) \qquad ( III )$$

From formula (III), it can be seen that the current I flowing through the OLED is independent of the threshold voltage Vth of the driving transistor TFT2. Wherein,

$$K = \frac{1}{2} \times μ \times {C}_{ox} \times \frac{W}{L}$$

wherein, μ denotes carrier mobility of the driving transistor TFT2, Cₒₓ denotes insulating layer capacitance per unit area, L and W respectively denote the channel length and width of the driving transistor TFT2.

Moreover, in the reset stage, the driving transistor TFT2 is discharged until it is cutoff, and the threshold voltage Vth of the driving transistor is stored in the storage capacitor C2.

The embodiment of the present invention has the benefits of improving the uniformity and stability of driving OLED, which improves the quality of the image display.

The embodiment of the present invention utilizes a pixel driving circuit of organic light emitting diode (OLED) display with 6T2C structure and the driving method thereof, so the threshold voltage of the driving transistor are compensated, then the current of the driving transistor is independent of the threshold voltage of the transistor when OLED is emitting light. It avoids the effects of the shift of the threshold voltage of the driving transistor on driving OLED, which improves the uniformity and stability of driving OLED, and then improves the quality of the image display.

The preferred embodiments of the present invention have been described, but not intending to impose any unduly constraint to the appended claims. Any deduction or modification according to the present invention is considered encompassed in the scope of protection defined by the claims of the present invention.

What is claimed is:

1. A pixel driving circuit of OLED display, comprising:
a scanning transistor TFT1, the source thereof being connected to a data line, the gate thereof being connected to a scanning control line, and the drain thereof being connected to a first terminal of a coupling capacitor C1;
a driving transistor TFT2, the gate thereof being connected to a second terminal of the coupling capacitor C1, and the scanning transistor TFT1 being used to control the coupling capacitor C1 to write a grayscale data voltage provided from the data line for the driving transistor TFT2;
a first compensation transistor TFT3, the source thereof being connected to the second terminal of the coupling capacitor C1, the drain thereof being connected to the drain of the driving transistor TFT2, and the gate thereof receiving a second switch driving signal SW2;
a second compensation transistor TFT4, the source thereof being connected to the drain of the driving transistor TFT2, the drain thereof being grounded, and the gate thereof receiving a fourth switch driving signal SW4;
a first reset transistor TFT5, the source thereof being connected to the gate of the driving transistor TFT2, the drain thereof being grounded, the gate thereof being connected to a first switch driving signal SW1, and a storage capacitor C2 be connected between the source and the gate thereof;
a second reset transistor TFT6, the source thereof being connected to the drain of the scanning transistor TFT1, the drain thereof being grounded, and the gate thereof being connected to a third switch driving signal SW3; and
an organic light emitting diode OLED, the negative electrode thereof being connected to the source of the driving transistor TFT2, and the positive electrode thereof being connected to a power line Vdd.

2. The pixel driving circuit of OLED display as claimed in claim 1, wherein the scanning transistor TFT1, the driving transistor TFT2, the first compensation transistor TFT3, the second compensation transistor TFT4, the first reset transistor TFT5, and the second reset transistor TFT6 are selected from a polysilicon thin film transistor, an amorphous silicon thin film transistor, a zinc oxide thin film transistor or an organic thin film transistor.

3. The pixel driving circuit of OLED display as claimed in claim 1, wherein the first switch driving signal SW1, the second switch driving signal SW2, the third switch driving signal SW3, and the fourth switch driving signal SW4 are provided from an external timing controller Tcon.

4. A pixel driving circuit of OLED display, comprising:
a scanning transistor TFT1, the source thereof being connected to a data line, the gate thereof being connected to a scanning control line, and the drain thereof being connected to a first terminal of a coupling capacitor C1;
a driving transistor TFT2, the gate thereof being connected to a second terminal of the coupling capacitor C1, and the scanning transistor TFT1 being used to control the coupling capacitor C1 to write a grayscale data voltage provided from the data line for the driving transistor TFT2;
a first compensation transistor TFT3, the source thereof being connected to the second terminal of the coupling capacitor C1, the drain thereof being connected to the drain of the driving transistor TFT2, and the gate thereof receiving a second switch driving signal SW2;
a second compensation transistor TFT4, the source thereof being connected to the drain of the driving transistor TFT2, the drain thereof being grounded, and the gate thereof receiving a fourth switch driving signal SW4;
a first reset transistor TFT5, the source thereof being connected to the gate of the driving transistor TFT2, the drain thereof being grounded, and the gate thereof being connected to a first switch driving signal SW1;
a second reset transistor TFT6, the source thereof being connected to the drain of the scanning transistor TFT1, the drain thereof being grounded, and the gate thereof being connected to a third switch driving signal SW3; and
an organic light emitting diode OLED, the negative electrode thereof being connected to the source of the driving transistor TFT2, and the positive electrode thereof being connected to a power line Vdd;
wherein, a storage capacitor C2 be connected between the source of the first reset transistor TFT5 and the negative electrode of the organic light emitting diode OLED.

5. The pixel driving circuit of OLED display as claimed in claim 4, wherein the scanning transistor TFT1, the driving transistor TFT2, the first compensation transistor TFT3, the second compensation transistor TFT4, the first reset transistor TFT5, and the second reset transistor TFT6 are selected from a polysilicon thin film transistor, an amorphous silicon thin film transistor, a zinc oxide thin film transistor or an organic thin film transistor.

6. The pixel driving circuit of OLED display as claimed in claim 5, wherein the first switch driving signal SW1, the second switch driving signal SW2, the third switch driving signal SW3, and the fourth switch driving signal SW4 are provided from an external timing controller Tcon.

7. A driving method of the pixel driving circuit of OLED display, the method comprising:
a reset stage: a scanning control line, a second switch driving signal SW2, and a fourth switch driving signal SW4 being under low level, a first switch driving signal SW1, and a third switch driving signal SW3 being under high level, a second compensation transistor TFT4, a first reset transistor TFT5, and a second reset transistor TFT6 being turned on, and the gate potential of a driving transistor TFT2 being reset and under low level;
a compensation stage: the scanning control line, the first switch driving signal SW1, and the fourth switch driving signal SW4 being under low level, the second switch driving signal SW2 and the third switch driving signal SW3 being under high level, the driving transistor TFT2, a first compensation transistor TFT3, and the second reset transistor TFT6 being turned on, the driving transistor TFT2 being under OFF state when the gate potential of the driving transistor TFT2 reaches the threshold voltage Vth;
a charging stage: the first switch driving signal SW1, the second switch driving signal SW2, the third switch driving signal SW3, and the fourth switch driving signal SW4 being under low level, the scanning control line being under high level, a scanning transistor TFT1 being turned on, a coupling capacitor C1 being charged, then the driving transistor TFT2 being turned on, and a grayscale data voltage being wrote into the gate of the driving transistor TFT2 through the coupling capacitor C1; and
an OLED light emitting stage: the scanning control line, the first switch driving signal SW1, the second switch driving signal SW2, and the third switch driving signal SW3 being under low level, the fourth switch driving signal SW4 being under high level, the power line being under high level, the gate-source voltage difference of the driving transistor TFT2 driving the OLED to emit light, and during the OLED light emitting stage, the gate-source voltage difference of the driving transistor TFT2 remaining unchanged until the next frame refresh.

8. The driving method as claimed in claim 7, wherein in the reset stage, the driving transistor TFT2 is discharged until it is cutoff, and the threshold voltage Vth of the driving transistor is stored in the storage capacitor C2.
